(19) United States
(12) Patent Application Publication
(10) Pub. No.: US 2014/0246256 A1
(43) Pub. Date: Sep. 4, 2014

(54) Fish Weighing & Floatation Device

(71) Applicant: Brent J. Stadther, Sacramento, CA (US)

(72) Inventor: Brent J. Stadther, Sacramento, CA (US)

(21) Appl. No.: 13/783,473

(22) Filed: Mar. 4, 2013

(51) Int. Cl. G01G 19/60

(52) U.S. Cl. CPC G01G 19/60
USPC 177/1; 177/148

(57) ABSTRACT

A fish weighing device with a micro-controller digital scale integrated with a floatation device connected to a tether at one end of the tether and having a fish attachment mechanism. The fish weighing device has a diaphragm attached at a lower portion of the floatation device. The fish weighing device is such that the diaphragm is connected to the digital scale using a rod or other electromechanical connection. The fish weighing device has the diaphragm connected to the tether through a rod, knots and a fishing connector such as a clip. A seal encompassing the diaphragm is attached to a lower portion of the floatation device. The digital scale has a digital display connected to the scale using buttons with ON/OFF and Calibration/Mode/Hold. Optionally, the device is connected or integrated with an antenna attached to the digital scale to communicate with a server or other devices.

### BACKGROUND OF THE INVENTION

1. Field of the Invention

The following description is directed to improvements in floatation devices that are designed to be used in conjunction with the fishing industry and the collection of animals in the wild, whether for sport or for consumption of the animal.

2. Description of Related Art

In the sports world, fishing contests have taken on a new urgency as an entertaining leisure activity. Competitions take place around the countryside setting the novice versus novice all the way to the master fisherman level. A typical contest is scored based on the combined weight of the five largest fish each contestant catches. On board the fishing vessel, a tank is kept to house the five largest fish for each contestant. As each new fish is caught by a contestant it is typically weighed and each measurement is then compared against prior catches. The smaller catches are thrown back into the water as a new larger catch replaces the aforementioned.

Various devices are known to string fish from the rim of a boat. U.S. Pat. No. 3,561,652 teaches a Floating Fish Stringer having a chain, a series of floating devices and safety pins arranged to provide both floatation and a strong series of connection points for the attachment of a plurality of fish. This patent does not show how to weigh the fish using the apparatus taught therein.

Another type of fish stringing device is described in U.S. Pat. No. 5,987,808 having a digital weight indicator. The stringer device has a digital indicator that is manually adjusted to indicate the weight of the fish attached to the stringer. The fish is attached to a clip, which in turn is attached to a cord and the aforementioned weight indicator. This device contains a number of disks bearing numbers which may be manually rotated to create a display of the weight of the fish and also has a floatation device attached thereto permitting a fisherman to easily find the weight of his previous catch. This patent suffers from its inability to actually weigh any of the fish. A fisherman would have to weigh each of the fish separately, manipulate the indicator, connect the fish to the clip and then toss it overboard until the next catch for comparison.

Finally, U.S. Pat. No. 6,696,650 teaches an electronic fish scale comprising a molded housing having upper and lower portions for supported hand grasping. An electronically controlled weight-sensing member and a viewable digital output screen are mounted within the housing The output screen is electronically connected to the weight-sensing member whereby a weight held by gravity causes a digital numeric display on the output screen equal to the fish weight. A fish-engaging assembly extends downwardly from the weight-sensing member through an aperture formed in the bottom of the housing, and includes a pair of opposed c-shaped jaws. A longitudinally movable jaw actuator is operably connected through a jaw control member via a rotation pin through diagonally extending aligned slots in the jaws whereby the jaws are opened when the jaw actuator is manually moved upwardly. A lower lip of a fish securely held and unhurt between the closed jaws will produce a digital display of the weight of the fish on the output screen. Housing contour facilitates hand-holding of the device and an array of unique digital data may be selectively displayed. This patent suffers from the complexity of its components that are excessively elaborate. Thus, there needs to be some solution that overcomes the prior art deficiencies described above.

### SUMMARY OF THE INVENTION

A fish weighing device has a digital scale integrated with a floatation device connected to a tether at one end of the tether and having a further attachment mechanism (lanyard, fishing clip to connect the mouth of the fish) at the other end of the tether. The fish weighing device has a diaphragm attached at a lower portion of the floatation device. The fish weighing device is such that a diaphragm is connected to the digital scale using a rod or other electromechanical connection. The fish weighing device has the diaphragm connected to the tether through a rod, knots and a fishing connector such as a clip or lanyard. Additionally, a seal encompasses the diaphragm therein, and the seal is attached to a lower portion of the floatation device. The digital scale has a digital display connected to the scale and is viewable externally from the device. The fish weighing device has a button having electronic function parameters connected to the scale having an ON/OFF parameter; further, a second button has the functions of Calibration/Mode/Hold. There is a micro-controller integrated with the digital scale that oversees the functions of the digital scale. Optionally, the device is connected or integrated with an antenna attached to the digital scale; the antenna transmits and receives data from other fish weighing devices and also transmits and receives data to and from a central server and is even optionally able to download and display GPS data.

A method of weighing fish starts by a user turning on a digital scale using a button on a floatation device then catching a fish, attaching the fish to a tether and weighing the fish using a digital scale attached to the tether. The fish's weight is stored in memory, and the process is repeated four more times: catching, attaching, weighting and storing. The process repeats by catching, attaching and weighing a sixth time, then comparing a sixth fish's weight to stored values in the digital scale. The user discards the lowest weight fish from a list stored in the digital scale if the sixth fish is larger, and then stores the sixth fish value over the lowest weight in the list on the digital scale. However, a user discards the sixth caught fish when it is of a lowest weight in comparison to those stored in the digital scale.

A fish weight measurement device having a digital scale integrated with a floatation device connected to a tether at one end of the tether and having a further attachment mechanism at its other end, a diaphragm attached at a lower portion of the floatation device such that the diaphragm is connected to the digital scale using a rod and the diaphragm is connected to the tether through a rod. The device has a seal encompassing the diaphragm therein and the seal attached to a lower portion of the floatation device.

### BRIEF DESCRIPTION OF THE SEVERAL VIEWS OF THE DRAWINGS

FIGS. 1A and 1B illustrate an improved Fish Weighing and Floatation Device showing the main components of the overall device.

FIG. 2 illustrates a close-up of the floating and weighing portion of the device of the instant embodiment

FIGS. 3A and 3B illustrate a close-up of the waterproof seal found at the bottom of a floatation device, including the diaphragm utilized in weighting fish.

FIGS. 4A and 4B illustrate how the invention is utilized aboard a fishing boat to measure the fish one by one that have been taken from the body of water, weighed and retained and/or marked, thrown back or are currently in line to be weighed by a fisherman in a competition or during routine work or sport.

### DETAILED DESCRIPTION OF THE EMBODIMENTS OF THE INVENTION

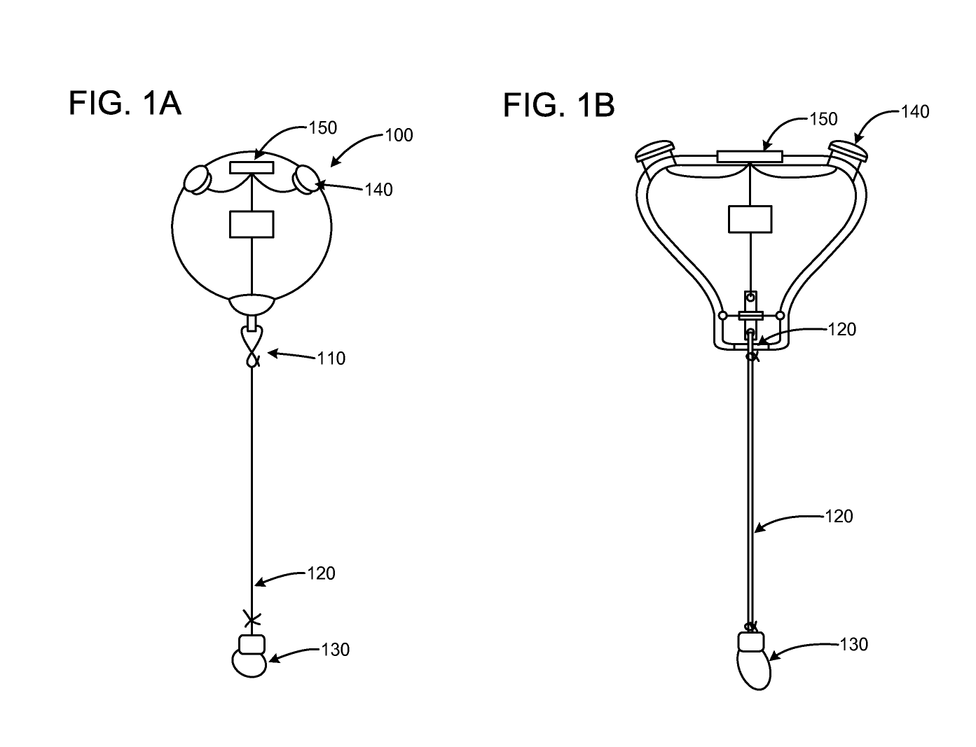

FIGS. 1a and 1b illustrate an improved Fish Weighing and Floatation Device showing the main components of the overall device. A floating device 100 is attached by a metal clip 110 to a tether 120 whose other end is attached to a lanyard type clip 130. The tether 120 is made from a heavy fishing line material, or from aircraft cable, nylon cord or urethane type materials. The floating device 100 houses two large hard plastic (PVC) push buttons 140 that are integral with the top surface of the floating device 100. Situated between the two large push buttons 140 is found a digital LCD or LED display 150 that is connected to the two large push buttons 140 through a weighing circuitry micro-controller (the controller has an integral memory referred to hereinafter as the micro-controller) housed internally to the floatation device 100; appropriate waterproof seals are provided so as to ensure that the connection from the LED to the micro-controller does not permit the passage of liquids. This circuitry is directly associated with the connection 110 to the tether 120 through electromechanical connections to the connection point 110. FIG. 1a illustrates one embodiment having an essentially spherical floatation device, and FIG. 1b illustrates an embodiment having a generally conical shape floatation device. Another difference between the two is that the clip 130 in FIG. 1a is external to a rubber seal, and in FIG. 1b, the clip 130 is internal to the rubber seal.

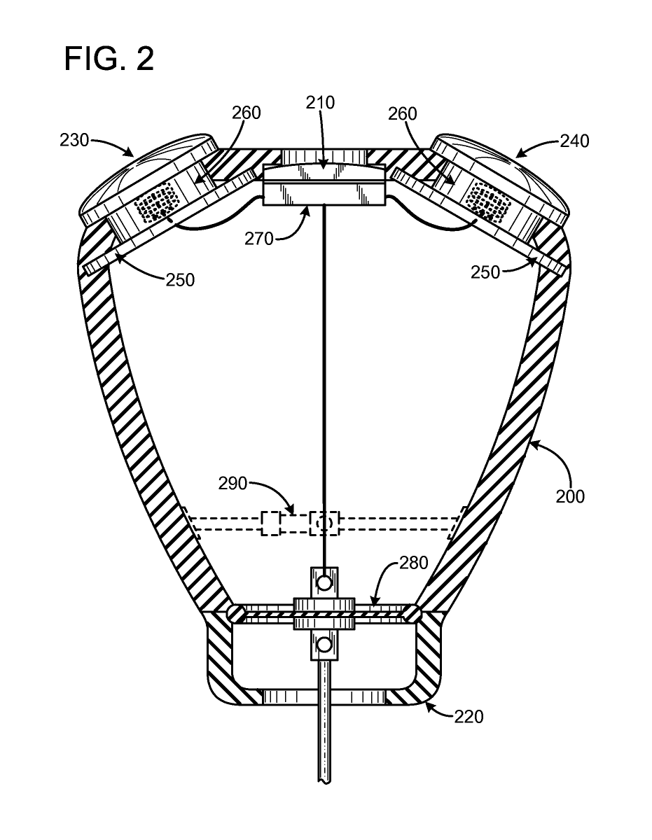

FIG. 2 further illustrates a close-up of the floating and weighing portion of the device of the instant embodiment. The figure shows the floatation device 200 that is formed as an essentially spherical shape with a matching hollowed internal spherical shape with a weighted bottom protrusion; alternatively, the shape is an inverted conical shape having a matching internal hollowed out inverted conical shape. It should be easily understood that the ‘conical’ nature is that of a curved cone such that as the cone tapers, it forms the shape of a curve from the broadest point of the top circumference of the upper surface of the float to the bottom narrowest point of the lower circumference of the end point of the float; this is the location where the float meets a seal 220. The float itself is hollow or alternatively filled with a styrofoam material that provides added rigidity to the device. Of course, in the event that it is filled with styrofoam material, sufficient molded space is provided for any and internal components necessary for the measuring and weighing functionality.

A water resistant sealed LED or Liquid Crystal Display 210 has been inserted within a hollowed out slot of the top surface of the float 200 such that the display 210 is permanently attached through two simple mechanical tongues that extend out from the internal sides of the hollowed slot and permit the edge of the display 210 to sit within and underneath the tongues snugly. It is thus an easy to assemble part in that it can be inserted under one tongue, and then the other tongue is stretched over the other side of the display. Alternative attachment schemes include screws, waterproof adhesives and the molding of the display 210 directly into the surface at the time the plastic surface of the float 200 is created.

At the top of the floatation device 200 are two electromechanical push button switches 230, 240 that are spring loaded against a pair of holders 250. These holders 250 are molded into the top of the surface of the floatation device in a semi-circular shape and angled outwards from the normal to the central top surface of the float 200. The top of push button switches 230, 240 are mushroom shaped with a circular surface at the top greater than the neck or lower portion of the switch that is inserted into the respective holder 250 on either side. A thin film 260 of flexible plastic, vinyl, neoprene or similar flexible material is concentrically connected about the exterior of the neck of each switch 230, 240 that is further attached to the edges of the holders 250. It is connected by heat treatment with a heat gun, waterproof adhesive or similar instrumentality. These films provide for the waterproofing of the push button switches 230, 240.

Each of these is further connected to electromechanical contacts found in the switches, and from there connected further on to a micro-controller sensor package 270 having all the electronics necessary to make a weight measurement and control, reset and otherwise manage the functions of the aforementioned display 210 to which the micro-controller sensor package 270 is likewise connected to. The micro-controller sensor package 270 is a waterproof sealed package that is disposed directly underneath the slot for the LED display by adhesive application or alternatively through the use of screws. The buttons 230 provide an ON/OFF choice for the electronic digital scale whilst the other button is utilized for CALIBRATION/MODE/HOLD functions. Upon activation of the ON button with user interaction of the button 230, the device starts up and automatically tests the present weight of the pulled tether. To force the micro-controller package into a calibration mode, the user selects button 240 once to set the digital scale into calibration mode such that the a known weight is measured to establish a baseline value for the validity of the scale measurement. A double click of the button 240 sends a reset signal to switch the device into reset mode thereby changing the scale from pounds and ounces to kilograms and grams. A final mode of the button 240 requiring three presses of the button is a HOLD function. This function is useful once a fish has been hooked to the bottom lanyard or clip and weighed. Once the weight has been taken it can be held in computer memory in a list of fish or alternatively displayed on the screen for easy reference. The top five fish or other convenient number of fish are stored in this list along with their weights.

Each of the floatation devices 100 may have an embedded antenna that facilitates communication with other units or with a server computing unit that is onboard a station for sport fishing competition, home use or other utility. The antenna is further connected through wired or wireless connection to the micro-controller sensor package 270 or is itself integrated with this package as one unit. Using Bluetooth, Wi-Fi or similar communication protocols, the micro-controller sensor package transmits signals and receives them to and from other units as well as from a server unit. In this fashion, competition data can be updated in real time and spread, displayed on other floatation display devices onboard a sewer display unit or even onto a large screen display typical of sporting events. The micro-controller units 270 can receive commands to change the display local to each floatation device giving indications to the user about the status of the competition, the current highest weight catch, the types of fish being caught, the leader board of top fishers and the time left in the game. These options are selected by cycling through the mode button 240, a menu of items being presented to the user that can be selected via clicking the mode button on a highlighted menu item. An optional embodiment permits collection of GPS sensor data.

At the bottom portion of the sensor floatation device 200 is a round rubber seal 220 attached by heating of the plastic and rubber, adhesive or similar attachment to the floatation device 200; This seal 220 encompasses a hard rubber diaphragm 280 and has been molded to fit about the diaphragm with a passageway that does not obstruct the lower metallic rod and tether attached thereto. This hard round rubber diaphragm 280 has its edge inserted into a circular depression along the inner lower portion of the floatation device 200 such that the diaphragm sits in the centerline of the float 200. The diaphragm 280 has two metallic rods glued to its surface with one extending upwards to the micro-controller 270 and the other extending downwards to the tether. Each of these has a hole through it by which connection to the diaphragm may be made. The tether is tied to the lower metallic piece through this hole and the micro-controller and its integrated sensor package 270 is connected electrically through the top metallic piece When a fish is placed on the tether clip, the fish's weight is transmitted via the tether to the diaphragm. As a result, the micro-controller sensor package 270 transducer senses this motion on the atomic scale and makes a reading of this fact that can be recorded, displayed, transmitted and otherwise used by the package 270. The metal rod can be extended closer to the sensor micro-controller package 270 in one implementation or the sensor (when sensor 290 is separate from the micro-controller package) itself brought in closer proximity by situating alongside the rod down below by suitable internal connection to the interior walls of the floatation device or via a protrusion therefrom or combination of the foregoing. Of course in this implementation suitable electrical connection from the micro-controller to the displaced sensor is also provided.

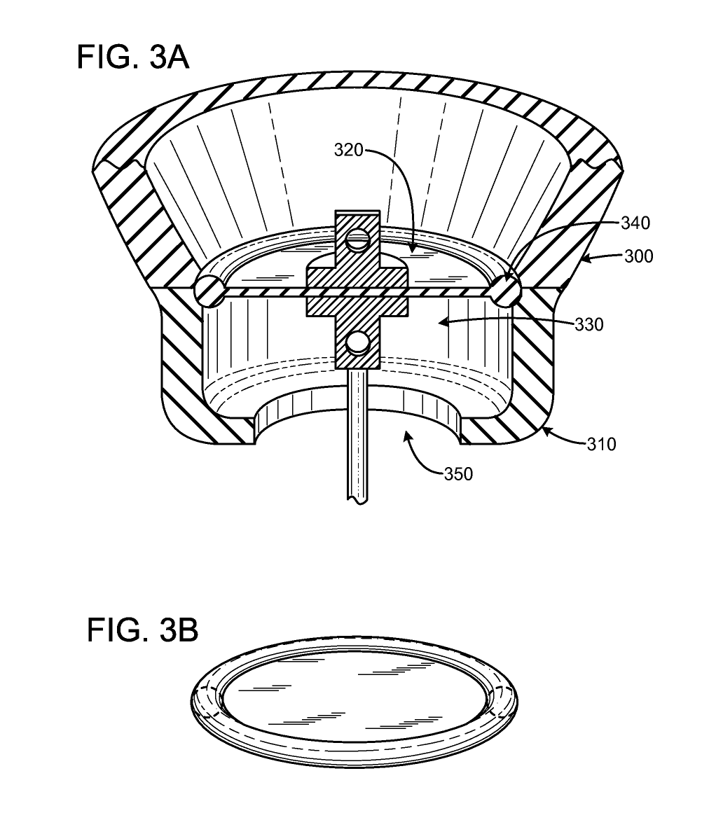

FIG. 3a illustrates how the floatation device 300 is integrated with the bard rubber seal 310 and the hard rubber diaphragm 320. The hard rubber seal 310 is essentially a piece of solid hard rubber that has cavities for motion 330 of the diaphragm 320 and for passage 350 of a metallic rod glued to the surface of the diaphragm therethrough that can extend outside or remain within the hard rubber seal depending upon the implementation. The hard rubber seal 310 is attached to the floatation device 300 through the use of adhesives, heat treating or other attachment mechanisms. The other main structure in the diagram is the diaphragm 320 that is a flat piece of hard rubber with a circumferential round ring 340 of rubber at its periphery. This round peripheral ring 340 shown in FIG. 3b is situated in a corresponding edge inside of the inner walls of the hollowed out chamber of the floatation device 300 and heat treated, connected via adhesive or other attachment mechanism. Also, an actuation chamber 330 sits underneath the diaphragm and permits movement of the aforementioned.

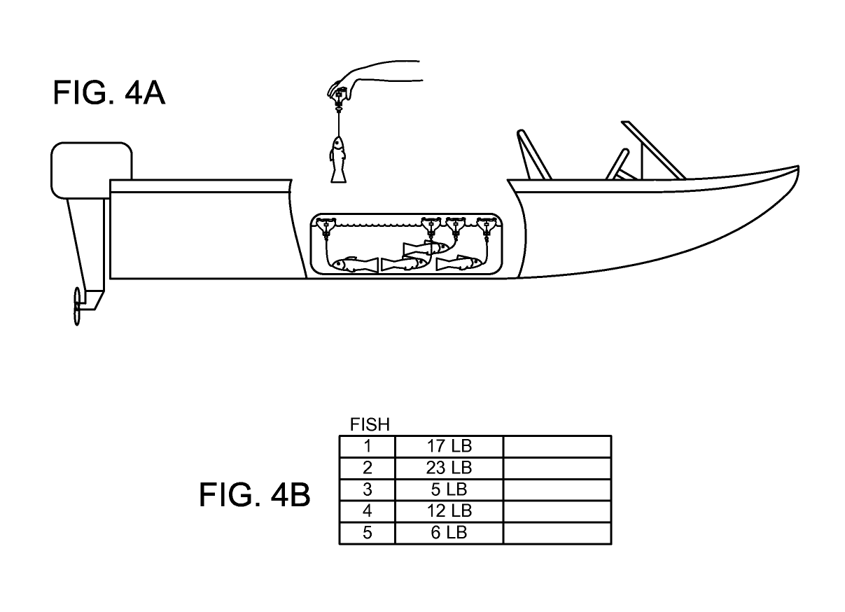

As discussed previously, in the sports world, fishing contests are scored based on the combined weight of the five largest fish each contestant catches. On board the fishing vessel of FIG. 4a one or more tank(s) is kept to house the five largest fish for each contestant. As each new fish is caught by a contestant, the fish is weighed and its weight is held using the electronic hold function of the micro-controller package; a user activates the push button to effect the saving of the fish's weight until a total of five fish are caught as shown in FIG. 4b. When the sixth fish is caught, its weight is compared to the five already caught in the digital display and if the sixth fish ways more than the least one of the other five, then that least one of the other five is returned to the water whilst the most recently caught fish is brought aboard. On the other hand, if the most recent catch is smaller than the other five already caught, then the most recent catch is returned to the water. Alternatively, one can manually examine the weight display of each one or tag a fish with the lowest weight with a colored marker such as a fishing lure or similar fishing item.

While there has been shown and described the preferred embodiment of the instant invention, it is to be appreciated that the invention may be embodied otherwise than is herein specifically shown and described and that, within said embodiment, certain changes may be made in the form without departing from the underlying ideas or principles of this invention as set forth in the Claims appended herewith.

I claim:

1. A fish weighing device comprising:
a digital scale integrated with
a floatation device connected to a
tether at one end of the tether and having
a further attachment mechanism at its other end.

2. The fish weighing device of claim 1 further comprising:
a diaphragm attached at a lower portion of the floatation device.

3. The fish weighing device of claim 2 such that the diaphragm is connected to the digital scale using a rod.

4. The fish weighing device of claim 2, such that the diaphragm is connected to the tether through a rod.

5. The fish weighing device of claim 2 further comprising:
a seal encompassing the diaphragm therein and the seal attached to a lower portion of the floatation device.

6. The fish weighing device of claim 1 further comprising:
a digital display connected to the scale.

7. The fish weighing device of claim 1 further comprising:
a button having electronic function parameters and connected to the scale.

8. The fish weighing device of claim 7 wherein the button has an ON/OFF parameter further comprising:
a second button has the functions of Calibration/Mode/Hold.

9. The fish weighing device of claim 1 further comprising:
a micro-controller integrated with the digital scale and overseeing the functions of the digital scale.

10. The fish weighing device of claim 1 further comprising:
an antenna attached to the digital scale.

11. The fish weighing device of claim 10 wherein the antenna transmits and receives commands from other fish weighing devices.

12. The fish weighing device of claim 10 wherein the antenna transmits and receives data to and from a central server.

13. A method of weighing fish comprising the steps of:
turning on a digital scale using a button on a floatation device
catching a fish
attaching the fish to a tether
weighing the fish using a digital scale attached to the tether.

14. The method of weighing fish of claim 13, further comprising the steps of:
storing the weight of a fish in memory.

15. The method of weighing fish of claim 14, further comprising the steps of:
repeating the process for four more times of:
catching a fish
attaching the fish to a tether
weighing the fish using a digital scale attached to the tether and
storing the weight of a fish in memory.

16. The method of weighing fish of claim 15, further comprising the steps of:
repeating the process of catching, attaching and weighing a sixth time then
comparing a sixth fish's weight to stored values in the digital scale.

17. The method of weighing fish of claim 16, further comprising the steps of:
discarding a lowest weight fish from a list stored in the digital scale if the sixth fish is larger and
storing the sixth fish value over the lowest weight in a list on the digital scale.

18. The method of weighing fish of claim 16, further comprising the steps of:
discarding the sixth caught fish when it is of a lowest weight in comparison to those stored in a digital scale.

19. A fish weight measurement device comprising:
a digital scale integrated with
a floatation device connected to a
tether at one end of the tether and having
a further attachment mechanism at its other end
a diaphragm attached at a lower portion of the floatation device such that the diaphragm is connected to the digital scale using a rod and the diaphragm is connected to the tether through a rod.

20. The fish weight measurement device of claim 19 further comprising:
a seal encompassing the diaphragm therein and the seal attached to a lower portion of the floatation device.
